(19) United States
(12) Patent Application Publication
(10) Pub. No.: US 2007/0224495 A1
(43) Pub. Date: Sep. 27, 2007

(54) Zinc/air cell

(76) Inventors: Daniel W. Gibbons, Southbury, CT (US); Michael Pozin, Brookfield, CT (US)

Correspondence Address: MR. BARRY D. JOSEPHS;ATTORNEY AT LAW, 19 NORTH STREET, SALEM, MA, 01970, US

(21) Appl. No.: 11/387,010

(22) Filed: Mar. 22, 2006

(51) Int. Cl. H01M 2/16; H01M 12/06; H01M 4/50

(52) U.S. Cl. 429/144; 429/246; 429/27; 429/224; 429/254

(57) ABSTRACT

A zinc/air depolarized cell wherein the anode comprises zinc particles, aqueous alkaline electrolyte, and aqueous alkaline electrolyte within said anode casing; a cathode within said cathode casing; and an electrolyte permeable separator between said cathode and anode; and a glue comprising crosslinked polyvinylalcohol, preferably crosslinked with a boron containing compound, said glue located between the separator and a side of said cathode to adhesively bond the separator to the cathode. The cell may be in the form of a button cell. The glue provides a strong adhesive bond between the separator, desirably of microporous polypropylene, and the cathode. The glue promotes ionic conductivity at the separator/electrode interface even when the zinc/electrolyte ratio within the anode is elevated.

### FIELD OF THE INVENTION

The invention relates to a metal/air cell preferably having an anode comprising zinc, a catalytic cathode, and a separator glued to the cathode with a glue preferably of crosslinked polyvinylalcohol containing boron.

### BACKGROUND

Zinc/air depolarized cells are typically in the form of miniature button cells which have particular utility as batteries for electronic hearing aids including programmable type hearing aids. Such miniature cells typically have a disk-like cylindrical shape of diameter between about 4 and 20 mm, typically between about 4 and 16 mm and a height between about 2 and 9 mm, preferably between about 2 and 6 mm. Zinc air cells can also be produced in somewhat larger sizes having a cylindrical casing of size comparable to conventional AAAA, AAA, AA, C and D size Zn/MnO₂ alkaline cells and even larger sizes.

The miniature zinc/air button cell typically comprises an anode casing (anode can), and a cathode casing (cathode can). The anode casing and cathode casing each have a closed end an open end and integral side walls extending from the closed end to the open end. The anode casing is fitted with an insulating seal ring which tightly surrounds the anode casing side wall. Anode material is inserted into the anode casing. Air diffuser, electrolyte barrier material, and cathode assembly are inserted into the cathode casing adjacent air holes in the cathode casing. The cathode assembly comprises a disk of cathode material coated and compacted onto a metal mesh screen. After the necessary materials are inserted into the anode and cathode casings, the open end of the cathode casing is typically pushed over the open end of the anode casing during assembly so that a portion of the cathode casing side walls covers a portion of the anode casing side wall with insulating seal therebetween. The anode and cathode casing are then interlocked in a second step by crimping the edge of the cathode casing over the insulator seal and anode casing. During the crimping procedure (or in a separate step) radial forces are also applied to the cathode casing walls to assure tight seal between the anode and cathode casings.

The cathode assembly which includes a disk of compacted cathode material may have a flat or domed shape. The cathode disk typically comprising a mixture of particulate manganese dioxide (also possibly including Mn₂O₃ and Mn₃O₄), carbon, and hydrophobic binder can be coated and compacted onto a metal mesh screen. A cathode assembly is formed by laminating a layer of electrolyte barrier material (hydrophobic air permeable film), preferably Teflon (polytetrafluoroethylene), to one side of the cathode disk and an electrolyte permeable (ion permeable) separator material to the opposite side of the cathode disk. The separator typically comprising a layer of microporous polypropylene is adhered or laminated to the side of the cathode disk intended to face the anode material so that the separator lies between anode and cathode. A conventional separator glue can be prepared by heating an aqueous suspension of polyvinylalcohol for a period until the suspended particles dissolve. The prepared glue is then coated onto a side of the separator and the glue coated side of the separator is in turn applied to the cathode surface. The cathode assembly with separator attached thereto can then be inserted into the cathode casing over the air diffuser. The cathode assembly is inserted into the cathode casing so that the separator faces the open end of the cathode casing. The cathode disk in the completed cell contacts the cathode casing walls around its perimeter and the separator lies between the cathode and anode material.

The anode casing of zinc/air button cells may be filled with a mixture comprising particulate zinc. Typically, the zinc mixture contains mercury and a gelling agent such as Carbopol (B.F. Goodrich) or Waterlock (Grain Processing Co.) and becomes gelled when electrolyte is added to the mixture. The electrolyte is conventionally an aqueous solution of potassium hydroxide. In the past zinc/electrolyte ratio in commercial zinc/air button cells would typically be under 3.3. Loading the anode casing with greater amount of zinc in relation to the electrolyte, that is, at higher zinc/electrolyte weight ratios has its allure. The greater amount of zinc in the fixed anode volume for a given size cell, can theoretically result in greater cell capacity and service life. Zinc/air button cells with higher zinc loading, that is, with higher zinc/electrolyte weight ratios in the anode have been attempted and are reported in the patent literature. See, Japanese Kokai publication No. 2000-21459 (Toshiba); Japanese patent 2,517,936 (Sony); and Japanese patent 3,647,218 (Toshiba). The references also allude to some of the problems associated with such higher loading of zinc in the anode. For, example, the problem of greater zinc anode expansion is mentioned as well as possible transient loss of electrical contact within the cell interior as the zinc expands.

It is believed high zinc/electrolyte weight ratio in the anode, e.g. higher than about 3.3, for example between about 3.3 and 6.0, can result in an expanding anode which may exert transient mechanical forces against the cathode causing transient bending forces on the cathode. This could cause a weakening of the adhesive bond between separator and cathode and possibly some delamination of portions of the separator from the cathode. The higher zinc/electrolyte weight ratios in the anode can also result in drying at the separator/cathode interface as the zinc and separator compete for the small amount of available electrolyte during discharge. This can lead to a deterioration in the ionic conductivity at the separator/electrode interface.

Applicant has determined that another problem which can occur or become exacerbated in zinc/air cells with anodes having high zinc/electrolyte weight ratios is that of mid-life voltage dip. It has been determined that such voltage dip can reduce the running voltage of the cell significantly during about the mid-life of the cell's service life. Although the voltage dip appears to be transient it can interfere with obtaining good cell performance at the time such voltage dip occurs. The magnitude of the dip is proportional to the applied load and can therefore be more problematic in higher rate applications or with devices requiring pulses of higher current.

The closed end of the cathode casing (when the casing is held in vertical position with the closed end on top) may have a flat raised portion near its center. This raised portion forms the positive terminal and typically contains a plurality of air holes therethrough. In this design, the cathode casing closed end also typically has an annular recessed step which surrounds the raised positive terminal. Alternatively, the closed end of the cathode casing may be completely flat across its diameter, that is, without any raised portion at its center. In such design the central portion of such flat area at the closed end of the cathode casing typically forms the cell's positive terminal. In either case, the closed end of the cathode casing of button zinc/air cells is punctured with one or more small air holes to allow air to enter the cell. Such air then traverses an air diffusion layer (or air diffuser) in order to reach the cathode disk.

The air diffuser material is normally composed of one or more sheets of air permeable paper or porous cellulosic material or polymeric material. Such permeable paper or porous cellulosic material allows incoming air to pass uniformly to the cathode assembly and also may serve as a blotter to absorb minor amounts of electrolyte which may leak into the air inlet space. The air diffuser is normally placed uniformly within the air inlet space (plenum space) between the closed end of the cathode casing and cathode assembly. The air diffuser material fills such air inlet space and covers the air holes in the closed end of the cathode casing. Commercial button size zinc/air cells which are commonly used in hearing aid devices may have only one air hole or may have a plurality of small air holes, for example, between 2 and 6 air holes and even more depending on cell size.

If the cell is not adequately sealed, electrolyte can migrate around the catalytic cathode assembly and leak from the cathode casing through the air holes. Also electrolyte leakage can occur between the crimped edge of the cathode can and insulator if this area is not tightly sealed. The wall thickness of commercial zinc/air button cells are typically greater than about 6 mil (0.152 mm), for example, between about 6 and 15 mil (0.152 and 0.381 mm). The potential for leakage is greater when the anode casing and cathode casing is of very thin wall thickness, for example, between about 2 and 5 mil (0.0508 and 0.127 mm). Such low wall thickness is desirable, since it results in greater internal cell volume.

After the cell is assembled a removable tab is placed over the air holes on the surface of the cathode casing. Before use, the tab is removed to expose the air holes allowing air to ingress and activate the cell.

It is desired to increase the zinc loading, that is, to increase the zinc/electrolyte weight ratio in the anode of zinc/air cells, particularly zinc/air button cells. It is desired to increase the zinc/electrolyte weight ratio in the anode to a range between about 3.3. and 6.0 and even somewhat higher.

It is desired to employ a flat or substantially flat cathode in conjunction with the higher zinc/electrolyte weight ratio in the anode of the zinc/air cell.

It is desired to alter the bonding morphology between separator and cathode in order to guard against the deterioration of ionic conductivity at the separator/electrode interface.

It is desired to reduce the magnitude of the mid-life voltage dip which may occur when the zinc/air cell is discharged with anode mixtures therein having high zinc/electrolyte weight ratio.

### SUMMARY OF THE INVENTION

The invention is directed to zinc/air cells, particularly miniature zinc/air cell in the form of button cells. Such miniature button cells typically have a cathode can and an anode can. There is at least one air hole, typically a plurality of air holes, running through the closed end of the cathode can. After the anode and cathode components are inserted into the respective cans, the cathode can side walls are crimped over the anode can side walls with insulator material therebetween.

It is desirable to increase the zinc loading in the anode mixture. This translates into a higher zinc/electrolyte weight ratio in the anode. It has been determined possible to utilize anode mixtures for zinc/air cells so that the zinc/electrolyte ratios are between about 3.3 and 6.0 preferably between about 4.0 and 5.5. The zinc/electrolyte weight ratios in the anode are between about 3.0 and 6.0 (wt. % zinc in the anode between about 75.0 wt. %, and 85.7 wt. %), desirably the zinc/electrolyte weight ratio in the anode is between about 3.3 and 5.5 (wt. % zinc in the anode between about 76.7 wt. % and 84.6 wt. %). Preferably the zinc/electrolyte weight ratio in the anode is between about 4.0 and 5.5 (wt. % zinc in the anode between about 80.0 and 84.6 wt %). The electrolyte is an aqueous alkaline electrolyte mixture, preferably an aqueous mixture comprising potassium hydroxide, which typically contains about 2 wt. % zinc oxide (ZnO). In the context of such higher zinc/electrolyte ratios in the anode mixture, the potassium hydroxide (KOH) concentration is desirably between about 30 and 40 wt. %, preferably between about 32 and 40 wt. %, for example, about 35 wt. %.

The higher zinc/electrolyte weight ratios in the anode mixture are desirable because they have the potential of increasing the cell's discharge capacity and service life under normal discharge conditions. However zinc anode mixtures expand during discharge. At higher zinc/electrolyte ratios there can be expected to be greater total volume expansion of the anode mixture. Such increased anode expansion can result in some weakening of the bond between portions of the separator and cathode in part due to mechanical bending forces on the separator/cathode interface. This in turn can result in loss in at least some surface to surface contact between the separator and the cathode when conventional glues such as unmodified (noncrosslinked) polyvinylalcohol are used to bond the separator to the cathode. The bending forces on the cathode and at the separator/cathode interface can be greater when the cathode is flat or of a substantially flat configuration. Representative zinc/air button cells with flat cathode assemblies are shown in U.S. Pat. No. 5,279,905 and U.S. Pat. No. 6,602,629 B1 and a representative domed shaped cathode assembly is shown in U.S. Pat. No. 3,897,265. Such loss of contact at the separator/cathode interface may cause voltage dips to occur, typically at the cell's mid service life, which although transient can nevertheless interfere with achieving overall good cell performance. Also, when conventional glues, such as unmodified polyvinylalcohol, are employed between separator and cathode, there can be a deterioration or loss in ionic conductivity at the separator/electrode interface, during cell discharge. Such loss in ionic conductivity could also be responsible for or contribute to the midlife voltage dip which is observed in zinc/air cells, particularly at elevated zinc/electrolyte weight ratios.

The loss in ionic conductivity at the separator/electrode interface at high zinc/electrolyte ratios in the anode may be due to a drying effect at the separator/cathode interface. During cell discharge the zinc particles and separator compete for electrolyte (hydroxyl ions). Electrolyte (hydroxyl ions) in the anode mixture decreases as zinc hydroxide Zn[OH]₂ and zincate ions, [Zn(OH)₄]⁻² buildup in the anode. Since the electrolyte is in short supply in anodes with higher than normal zinc/electrolyte ratios, such competition can result in a drying effect at the separator/cathode interface. The drying effect at the separator/cathode interface, exacerbated by high zinc/electrolyte weight ratios in the anode, are believed to be a possible cause of deterioration in ionic conductivity between separator and cathode, such as unmodified polyvinylalcohol are used. Such loss in ionic conductivity tends to occur, especially at the cell's midlife.

The running voltage profile of a conventional zinc/air cell (anode with zinc/electrolyte ratio under 3.3) is relatively flat. In the normal cell the initial load voltage is about 1.3V. The cell has a fairly flat voltage profile which very gradually falls off (averaging about 1.0 to 1.1V) until a cut off voltage of about 0.9V is approached, at which point the voltage falls off fairly abruptly to 0. With anode at high zinc/electrolyte ratio, e.g. between about 3.3 and 6.0, a mid-life voltage dip has been observed. This causes a dip in the running voltage for a period of time which occurs approximately about midway during the cell's discharge service life. The mid-life voltage dip can occur for a period which may typically comprise between about 10 and 15 percent of the total service life of the cell. During that period a maximum voltage dip may occur, which lasts only very briefly. After the period of voltage dip, the cell's running voltage profile appears to recover to normal levels until the cut off voltage of about 0.9V is reached.

A significant reduction in the mid-life voltage dip of the zinc/air cell, thereby allowing the preparation of anodes with high zinc/electrolyte weight ratios of between about 3.3 and 6.0, can be obtained, as described herein, by improving the adhesive glue used to bond the separator to the cathode. It has been determined that an improved glue between separator and cathode is a polyvinylalcohol crosslinked with a boron containing compound forming a crosslinked polyvinylalcohol containing boron. The glue is prepared by mixing boric acid powder in an aqueous solution of polyvinylalcohol powder dissolved in distilled water. The pH of the mixture is desirably less than about 6.0. The mixture is heated to an elevated temperature between about 80° C. and 95° C. for a period of time sufficient to dissolve the polyvinylalcohol and form a solution. This forms a thickened glue which is not yet crosslinked, but may be placed in storage until ready for use. The glue can then be applied between the two surfaces desired to be bonded, e.g. separator and cathode surfaces, to bond the separator to the cathode. Full crosslinking of the polyvinylalcohol with the boric acid does not occur until after the glue is subsequently left to dry after it has been applied at the separator/cathode interface. The crosslinking with the boron containing compound appears to take place primarily at the 1,2 diol cites within the polyvinylalcohol structure. The crosslinking takes place between at least a portion of the boron containing compound comprising boron and such diol sites within the polyvinylalcohol structure. The improved separator glue can be prepared with the weight ratio of boric acid to polyvinylalcohol (dry basis) desirably between about 1/100 and 12/100, preferably between about 3/100 and 5/100.

The polyvinylalcohol powder can be mixed with an aqueous solution of borate compounds such as, for example, potassium borate, sodium borate, or zinc borate, and any mixture thereof, with or without boric acid also included. (It may also be possible to substitute or include organic boric acid esters to the borate mixture.) When such borate compounds are employed, it would be desirable to calculate the amount of the borate compounds (borate salts, boric acid, boric acid esters, etc.) on the basis of μm-moles, M, of total borate compounds in relation to 100 grams of polyvinylalcohol powder, namely, M/100. Thus, the ratio of gm-moles of borate compounds to 100 gram polyvinylalcohol, expressed as M/100, is desirably between about 0.0161/100 and 0.194/100, preferably between about 0.0484/100 and 0.0806/100. The starting polyvinylalcohol powder desirably has a molecular weight between about 20,000 and 250,000, preferably between about 50,000 and 150,000, and a mol % hydrolysis (alcoholysis) of the acetate groups desirably between about 90 mol %, preferably between about 95 and 100 mol %. The polyvinylalcohol admixed with the aqueous borate solution desirably has a pH below about 6.0. The mixture can be heated at elevated temperatures to dissolve the polyvinylalcohol as above described to form the glue, which may be placed in storage until needed. This method of preparation of the glue mixture at pH below about 6.0 prevents full crosslinking from occurring until after the glue is applied to the separator/cathode interface surfaces and the glue subsequently left to dry. Crosslinking takes place between at least a portion of the boron containing compound comprising boron and diol sites within the polyvinylalcohol structure. The full crosslinking of the polyvinylalcohol with the boron containing compounds occurs upon drying, whereupon a durable adhesive bond having excellent ionic conductivity is formed between the separator and cathode.

The improved separator glue of the invention results in a durable adhesive bond of changed bonding morphology (compared to prior art) which resists deterioration in ionic conductivity, especially during the cell's midlife. The modified glue shows improved wettability and better water retention. These benefits lower midlife voltage dip. The polyvinylalcohol crosslinked with boron containing compound can be produced in a viscous liquid which can be readily coated uniformly onto a surface of the separator, preferably of microporous polypropylene. When the separator is coated in this manner and applied directly to the catalytic cathode, a durable adhesive bond is produced at the separator/cathode interface. The glue coating dries to form a crosslinked film bond between the separator and cathode preventing deterioration in ionic conductivity at the separator/cathode interface, especially during the cell's midlife period. Such adhesive bond does not appear to be adversely affected by the presence of alkaline electrolyte in the anode or increased mechanical bending forces on the cathode caused by anode expansion. The separator/cathode adhesive bond resulting from the improved glue of the invention resists drying of the separator/cathode interface and also allows electrolyte to pass therethrough. In sum the separator coated with the improved glue of the invention promotes ionic conductivity at the separator/cathode interface, even when the anode mixture is prepared with high zinc/electrolyte weight ratios between about 3.3 and 6.0, more preferably between about 4.0 and 5.5. The improved separator glue of the invention has also been determined to reduce the magnitude of transient voltage dips which may typically occur in zinc/air cells having anodes with high zinc/electrolyte weight ratios.

Thus, the zinc/air cell of the invention has an improved glue for adhering the separator to the cathode composite. The cell has an anode mixture desirably having a zinc/electrolyte weight ratio between about 3.0 and 6.0 (wt. % zinc in the anode between about 75.0 wt. %, and 85.7 wt. %), desirably the zinc to electrolyte weight ratio is between about 3.3 and 5.5 (wt. % zinc in the anode between about 76.7 wt. % and 84.6 wt. %), preferably between about 4.0 and 5.5 (wt. % zinc in the anode between about 80.0 and 84.6 wt %). The electrolyte preferably comprises potassium hydroxide (KOH) in concentration between about 30 and 40 wt. %, preferably between about 32 and 40 wt. %, for example about 35 wt. %. (If the zinc is amalgamated with mercury the weight of zinc is understood to include the mercury.) The separator glue is preferably polyvinylalcohol cross linked with boron. The separator preferably comprises a layer of microporous polypropylene. A preferred separator comprises a layer of microporous polypropylene laminated to a layer of nonwoven polypropylene fibers. In such separator it is preferred to coat the improved glue onto the microporous polypropylene side but alternatively the glue may be coated onto the polypropylene fiber side.

Although polypropylene separators are preferred, the improved separator glue of the invention could be used to coat other separators used in zinc/air cells, for example, separators of cellophane, polyvinylchloride, or acrylonitrile material. The improved glue of the invention is preferably coated on the separator as a viscous liquid at coating thickness between about 1 and 12 mil (0.0254 and 0.305 mm). When a microporous polypropylene separator is used the improved glue of the invention does not appear to be absorbed into the microporous polypropylene structure, but remains essentially as a film layer on the surface of the separator and dries to form a uniform film adhesive bond between separator and cathode. The glue dries to form a durable adhesive bond having a dry film thickness of between about 0.05 and 0.6 mil (0.00127 and 0.0152 mm) between the separator and cathode. This compares to separator thicknesses which are typically between about 2 and 6 mil (0.0508 mm and 0.152 mm) for zinc/air button cells. For example, a preferred separator for the zinc/air cell is CELGARD CG 5550 which comprises a polypropylene microporous layer laminated to a nonwoven fabric of polypropylene fibers. The CELGARD CG 5550 separator has an overall thickness of 3.7 mil (0.0940) mm). Thus, the dried glue coating bonding the separator to the cathode, is at least an order of magnitude thinner than the separator itself. The dried glue coating because of such shallow thickness, could not function as a separator material, to replace CELGARD CG 5550 separator or other conventional separator for the zinc/air cell. (Because of its low thickness, the dried glue coating of the invention would cause shorting between anode and cathode, if it were used alone to replace conventional separators.)

The miniature zinc/air button cell of the invention typically has a disk-like cylindrical shape of diameter between about 4 and 20 mm, typically between about 4 and 16 mm, and a height between about 2 and 9 mm, preferably between about 2 and 6 mm. The zinc/air cells may have anode can and cathode can wall thickness, typically covering a range between about 2 mil and 15 mil (0.0508 and 0.381 mm). Desirably, the zinc/air cells may have thin anode can and cathode can walls of thicknesses between about 2.0 and 5 mils (0.0508 and 0.127 mm). These wall thicknesses may apply to the thickness of a single layer (unfolded) anode and cathode can side wall and also the thickness of the closed end of the anode and cathode can. When the anode can wall thicknesses are very thin, that is, approaching the lower limit of the above wall thickness ranges, it is preferred to have the anode can side wall once folded in effect forming a double side wall. In such embodiment it will be appreciated that the above wall thickness ranges apply to each one of the double side walls.

### BRIEF DESCRIPTION OF THE DRAWINGS

The invention will be better understood with reference to the drawings in which:

FIG. 1 is an isometric cross sectional view of an embodiment of the zinc/air cell of the invention.

FIG. 2 is an exploded view of a preferred embodiment of the catalytic cathode assembly shown in FIG. 1.

### DETAILED DESCRIPTION

The invention is directed principally to air depolarized electrochemical cells. Such cells have a metal anode, typically comprising zinc within an anode casing, and there is an air inlet to the cathode material within the cathode casing. The cell is commonly referred to as a metal/air or air-depolarized cell, and more typically a zinc/air cell.

The zinc/air cell of the invention is desirably in the form of a miniature button cell. It has particular application as a power source for small electronic devices such as hearing aids. But such cells may also be used to power other electronic devices. The miniature zinc/air button cell of the invention typically has a disk-like cylindrical shape of diameter between about 4 and 20 mm, for example, between about 4 and 16 mm, preferably between about 4 and 12 mm. The miniature zinc/air button cell has a height between about 2 and 9 mm, preferably between about 2 and 6 mm. The miniature zinc/air cell typically has an operating load voltage between about 1.3 Volts to 0.2 Volts. The cell typically has a substantially flat discharge voltage profile between about 1.1 and about 0.9 Volts whereupon the voltage can then fall fairly abruptly to zero. The miniature zinc/air cell can be discharged at a rate usually between about 0.2 and 25 milliamperes. The term “miniature cells” or “miniature button cells” as used herein is intended to include such small size button cells, but is not intended to be restricted thereto, since other shapes and sizes for small zinc/air cells are possible. For example, zinc air cells could also be produced in somewhat larger sizes having a cylindrical casing of size comparable to conventional AAAA, AAA, AA, C and D size Zn/MnO₂ alkaline cells and even larger.

The cell of the invention may contain added mercury, for example, about 3 percent by weight of the zinc in the anode or can be essentially mercury free (zero added mercury cell). In such zero added mercury cells there is no added mercury and the only mercury present is in trace amounts naturally occurring with the zinc. Accordingly, the cell of the invention can have a total mercury content less than about 100 parts per million parts by weight of zinc, preferably less than 50 parts per million parts (ppm) by weight of zinc, more preferably less than about 20 parts per million parts by weight of zinc. (The term “essentially mercury free” as used herein shall mean the cell has a mercury content less than about 100 parts per million parts by weight of zinc.) The cell of the invention can also have a small amount of lead additive in the anode. If lead is added to the anode, the lead content in the cell can typically be between about 100 and 800 ppm of zinc in the anode. However, the cell may also be essentially lead free, that is, the total lead content is less than 30 ppm, desirably less than 15 ppm of zinc in the anode.

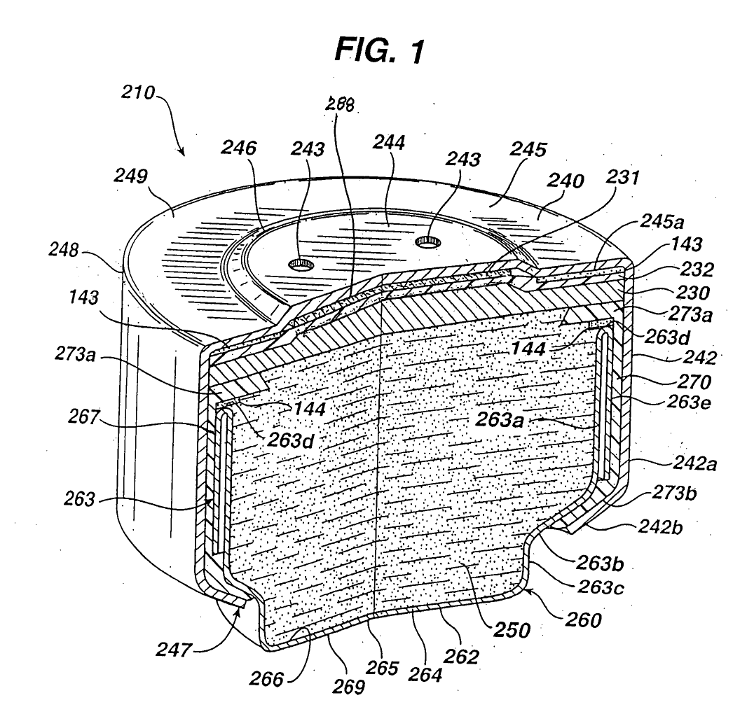

The zinc/air cell 210 of the invention (FIG. 1) has an anode casing 260, a cathode casing 240 and electrical insulator material 270 therebetween. The anode casing 260 and cathode casing 240 are preferably each in the form of a can or cup having a closed end and opposing open end. The anode casing 260 has body 263 forming the side walls, an integral closed end 269, and an open end 267. The cathode casing 240 has a body 242, an integral closed end 249 and an open end 247. The closed end 249 of the cathode casing (when the casing is held in vertical position with the closed end on top) typically has a raised portion 244 near its center. This raised portion 244 forms the positive terminal contact area and typically contains a plurality of air holes 243 therethrough. The cathode casing closed end 249 also typically has an annular recessed step 245 which extends from the peripheral edge 246 of the raised terminal portion to the outer peripheral edge 248.

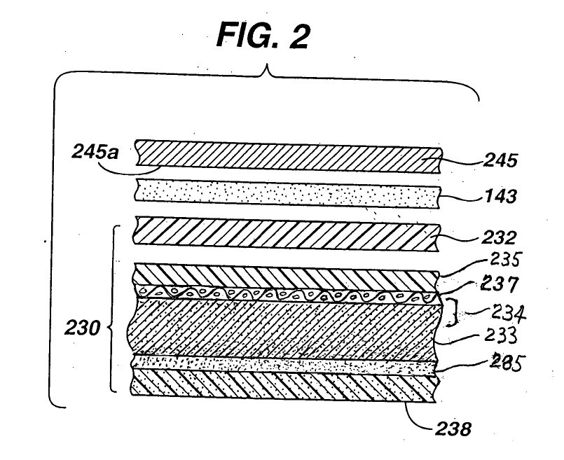

The anode casing 260 (anode can) contains an anode mixture 250 comprising particulate zinc and alkaline electrolyte. The particulate zinc is desirably alloyed with between about 100 and 1000 ppm indium. The zinc particles may also be plated with additional indium, preferably between about 100 and 1500 ppm indium. In this context the anode mixture 250 preferably contains zero added mercury. The cathode casing 240 has a plurality of air holes 243 in the raised portion 244 of its surface at the closed end thereof. A cathode catalytic assembly 230 containing a catalytic composite material 234 (FIG. 2) is placed within the casing proximate to the air holes. The catalytic composite 234 comprises a catalytic cathode mixture 233 in the form of a disk coated on a screen 237. During cell discharge, the catalytic material 233 facilitates the electrochemical reaction with ambient oxygen as it ingresses through air holes 243. An adhesive sealant 143 is applied along a portion of the inside surface of cathode casing 240. In a preferred embodiment the adhesive can be applied as a continuous ring on the inside surface 245a of recessed annular step 245 at the closed end 249 of the casing as shown in FIG. 1 and as also described in U.S. Pat. No. 6,436,156 B1. If the closed end of the cathode casing is flat, that is, does not have a recessed step 245, the adhesive sealant 143 can be applied to the inside surface of the closed end 249 adjacent the outer peripheral edge 248 of said closed end. In such latter case the adhesive sealant 143 is desirably applied as a continuous ring to the inside surface of closed end 249 such that the continuous ring of adhesive 143 has an outside diameter of between about 75 percent and 100 percent, preferably between about 90 and 100 percent, more preferably between about 95 and 100 percent of the inside diameter of closed end 249.

A representative cathode casing 240 (cathode can) is shown in FIG. 1. The cathode casing 240 is in the form of a can which has a closed end 249 and opposing open end 247 with body 242 (side walls) therebetween. The central portion 244 at the closed end 249 may be raised (as shown) and forms the positive terminal contact region. However, the entire closed end 249 may be flat, that is, without any raised central portion. There are one or more air holes 243 through the cathode casing closed end 249. There is an air inlet space 288 (plenum region) between the cathode casing closed end 249 and cathode assembly 230. Generally, the air inlet space 288 (plenum region) may be regarded as the available space between the inside surface of the cathode casing closed end 249 and cathode assembly 230 before any air diffuser material 231 is inserted therein. Conventionally, the air diffuser material is composed of air permeable paper or porous cellulosic material which is normally inserted to completely fill the available air inlet space 288.

In the embodiment shown in FIG. 1 there is a raised central portion 244 at the cathode casing closed end 249. In this embodiment (FIG. 1) the air inlet space 288 (plenum region) is the available space between the inside surface of the raised portion 244 of cathode casing closed end 249 and cathode assembly 230 before air diffuser material (or comparable) is inserted therein. (For the purposes of this description any electrolyte barrier sheet, such as electrolyte barrier sheet 232 on the cathode assembly 230, may be considered as part of the cathode assembly 230.) There are one or more air holes 243 through said raised portion 244. In a representative cathode casing 240, for example, for a 312 size cell, namely, button cell with overall diameter 0.304 inch (7.72 mm) and height 0.135 inch (3.43 mm), there may typically be five equispaced air holes 243 each of diameter between about 0.0045 and 0.012 inches (0.114 and 0.305 mm) through the raised portion 244 of the cathode casing closed end 249. However, it will be appreciated that there may be more air holes or as few as a single air hole depending on the size of the cell and size of the air hole, which may be somewhat more or less than the above specified hole size.

A cathode catalytic assembly 230 (FIGS. 1 and 2) can be formed by first coating cathode material onto mesh screen 237 to form cathode composite 234. One side of cathode composite 234 may be laminated with a layer of hydrophobic electrolyte barrier film material 235, preferably Teflon (polytetrafluoroethylene) and an optional second Teflon layer 232 added. The electrolyte barrier film 235, preferably of Teflon, has the property that it is permeable to air, yet keeps water and electrolyte from passing therethrough. The barrier film layer 235 can be applied to the cathode composite 234 by application of heat and pressure. Separator material 238 is glued or laminated to the opposite side of cathode composite 234, preferably directly to the exposed side of cathode material 233 to form the completed cathode assembly 230 (FIG. 2).

In a preferred embodiment a side of separator 238 is coated with the improved separator glue 285 of the invention and the glue coated side of the separator is applied directly to cover the exposed surface of cathode 233 as shown in FIG. 2. (The surface of cathode material 233 may also be separately coated with improved glue 285.) A preferred glue 285 of the invention is a polyvinylalcohol crosslinked with a boron containing compound forming a crosslinked polyvinylalcohol containing boron. The desired crosslinking of polyvinylalcohol with boron ions and final formation of glue 285 may be achieved as follows: First dissolve boric acid in distilled water without heating. Then add polyvinylalcohol powder gradually to the boric acid/water solution and continue to mix cold until a milky white dispersion or suspension is formed. The mixture is then heated in a vessel at elevated temperature, e.g. between about 80° C. to 95° C., and held at that temperature for a period of time, e.g. about 1 hour, to achieve full dissolution. (The heating temperature may be adjusted slightly depending on the degree of hydrolysis of the polyvinylalcohol.) A viscous glue 285 is obtained which can be placed in ambient storage until needed. A preferred polyvinylalcohol powder is available under the trade designation ELVANOL 71-30 from E.I. DuPont Co. Such commercial polyvinylalcohol comprises mostly 1,3 diol units but 1,2, diol units can make up a small fraction, typically between about 0.5 to 6% of the diols. The crosslinking of polyvinylalcohol with the boron containing compound is believed to occur essentially only at the 1,2 diol sites. ELVANOL 71-30 polyvinylalcohol (PVA) powder is a fully hydrolyzed general purpose grade of polyvinylalcohol. The percent hydrolysis is between about 99 and 99.8 mol % (mol % hydrolysis of acetate groups on a dry basis.) ELVANOL polyvinylalcohol (PVA) is classified as a medium grade viscosity PVA. That is, it has a solution viscosity of between about 27-33 centipoise when 4 wt. % of the PVA powder is diluted in water at 20° C.

The polyvinylalcohol powder can be mixed with an aqueous solution of borate containing compounds such as, for example, potassium borate, sodium borate, or zinc borate, and any mixture thereof, with or without boric acid also included. (It may also be possible to substitute or include organic boric acid esters to the borate mixture.) The desirable weight ratio of borate compounds (e.g. total boric acid and borates) to the polyvinylalcohol (dry basis) is desirably between about 1/100 and 12/100, preferably between about 3/100 and 5/100. When such borate compounds, are employed it would be desirable to calculate the amount of the borate compounds (borate salts, boric acid, boric acid esters, etc.) on the basis of gm-moles, M, of total borate compounds in relation to 100 grams of polyvinylalcohol powder, namely, M/100. Thus, the ratio of moles of borate compounds to 100 gram polyvinylalcohol, expressed as M/100, is desirably between about 0.0161/100 and 0.194/100, preferably between about 0.0484/100 and 0.0806/100. The starting polyvinylalcohol powder desirably has a molecular weight between about 20,000 and 250,000, preferably between about 50,000 and 150,000, and a mol % hydrolysis (alcoholysis) of the acetate groups desirably between about 90 mol %, preferably between about 95 and 100 mol %. The polyvinylalcohol powder admixed with the aqueous borate solution desirably forms a mixture having a pH below about 6.0. (Phosphoric acid may be conveniently added to the mixture to achieve the desired level of pH below about 6.0, desirably between about 4.5 and 5.0. A surfactant such as a phosphate ester surfactant RA-600 from Rhone Poulenc may also optionally be added in amount, typically between about 50 and 500 ppm based on the total aqueous mixture.) The mixture can be heated at elevated temperatures as above described to dissolve the polyvinylalcohol and form glue 285. The mixture is then left to cool to ambient temperature forming glue 285, which may be placed in storage until needed. This method of preparation of the glue mixture at pH below about 6.0, prevents gelation and full crosslinking from occurring until after the glue 285 is applied to the separator/cathode interface surfaces and the glue subsequently left to dry. That is, the full crosslinking of the polyvinylalcohol with the boron containing compounds occurs upon drying of the glue, whereupon a durable adhesive bond promoting excellent ionic conductivity is formed between the separator 238 and cathode 233.

When boron containing compounds are used as crosslinking agents, the crosslinking occurs predominately at the 1,2 diol sites of the polyvinylalcohol. The crosslinked polyvinylalcohol will thus have boron captured at the 1,2 diol sites thereby crosslinking neighboring chains of polyvinylalcohol, regardless of whether borates or boric acid is used as crosslinking agent.

The following is a representative chemical diagram showing the nature of such crosslinked polyvinylalcohol:

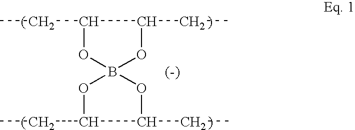

It is believed that the glue 285 of the invention can be made from other crosslinked polyvinylalcohols. The crosslinked polyvinylalcohol forms a more rigid network structure compared to the unmodified (noncrosslinked) polyvinylalcohol. The crosslinked polyvinylalcohol can also display improved wettability due to a reduction in contact angle and water retention can also be improved. In general, the crosslinked polyvinylalcohol glue 285 is expected to hold electrolyte better than the unmodified polyvinylalcohol, which tends to lose electrolyte over time. The loss of electrolyte at the separator 238/cathode 233 interface can lead to a drying of the separator 238 itself, which in turn can lead to loss in ionic conductivity and undesirable cell performance, such as mid-life voltage dip. Although the above described glue 285 comprising crosslinked polyvinylalcohol containing boron therein is preferred and appears to promote ionic conductivity, it is believed that other glues 285 formed of other crosslinked polyvinylalcohol can also work advantageously, that is, prevent drying at the separator/cathode interface and promote ionic conductivity.

Thus, an alternative glue 285 may be prepared by employing a polyamide-epichlorohydrin as a crosslinking agent for polyvinylalcohol. Such crosslinking agent is available under the trade designation POLYCUP 172 (polyamide-epichlorohydrin) crosslinking agent from Hercules Inc. Thus a glue 285 may be prepared by preparing an aqueous dispersion of polyvinyl alcohol, desirably employing ELVANOL 71-30 polyvinylalcohol (PVA) powder (E.I. DuPont) and adding POLYCUP 172 and mixing until a homogenous dispersion is obtained. The POLYCUP 172 crosslinking agent desirably comprises between about 1 to 10 parts by weight of active solids with respect to 100 parts by polyvinylalcohol powder. Strictly speaking, POLYCUP 172 is a thermoset that crosslinks (reacts) with carboxyl or hydroxyl functionalities and should be added shortly before use. That is, the polyvinylalcohol solids should be dissolved by means of heating to 80-95° C. while mixing and then allowed to cool. The pH may then be adjusted between about 7 and 9.5, and preferably between about 7 and 8 with ammonium hydroxide. Next the POLYCUP 172 crosslinking agent is added at a ratio of between about 1 to 10 parts by weight of active POLYCUP solids with respect to 100 parts by weight polyvinylalcohol powder. Prepared in this manner, the resulting polyvinylalcohol solution will have a shelf life between 2 and 7 days. The mixture prepared in this manner may be used as a glue 285 which may be used to adhere separator 238 to cathode 233. After glue 285 is applied at the separator/cathode interface it becomes fully crosslinked upon drying resulting in a durable electrolyte permeable adhesive interface bond between separator 238 and cathode 233. Depending on the drying temperature used, optimal cure may not be achieved for 1-2 days after drying.

Another crosslinking agent which could be used to crosslink polyvinylalcohol forming a suitable glue 285 may be ammonium zirconium carbonate. Such crosslinking agent is available under the trade designation BACOTE-20 (ammonium zirconium carbonate) from Magnesium Elektron, Inc. An aqueous mixture of polyvinylalcohol, e.g. employing ELVANOL 71-30, may first be prepared. Sufficient alkaline is added, in order to bring the mixture to a pH between about 7.5 to 10. Then BACOTE-20 crosslinking agent is added to the mixture in amount between about between about 1 to 10 parts by weight, preferably between about 5 to 7 parts by weight BACOTE-20 (on as received or trade solution basis) with respect to 100 parts by weight polyvinylalcohol powder. The mixture can then be mixed at ambient temperature (no heating required) until a homogenous solution is obtained. (Heating the mixture should be avoided, since this could cause premature crosslinking of the polyvinylalcohol.) At this point, the Bacote 20 modified PVA is ready for use as a glue 285. After glue 285 is applied at the separator/cathode interface, it becomes fully crosslinked upon drying resulting in a durable electrolyte permeable adhesive interface bond between separator 238 and cathode 233.

The use of such glues 285 prepared by crosslinking polyvinylalcohol with above alternative crosslinking agent POLYCUP 172 polyamide-epichlorohydrin or BACOTE-20 (ammonium zirconium carbonate) has not actually been tested in the context of bonding separator 238 to cathode 233. However, the beneficial use of such alternative crosslinked polyvinylalcohol as a glue 285 at the separator/cathode interface is predicted based on the structural rigidity of the crosslinked polyvinylalcohol polymer and the very good results obtained with polyvinylalcohol crosslinked with boron containing compounds.

The separator 238 is an electrolyte permeable sheet coated on one side with improved glue 285 and the glue coated separator 238 adhered directly to cathode material 233 as above described (FIG. 2). A preferred separator comprises a microporous polypropylene layer. A desirable polypropylene separator is available under the trade designation CELGARD CG 5550 from Polypore International, Inc. Such separator has a dual layer, namely, a microporous polypropylene layer laminated to a layer composed of nonwoven polypropylene fibers. Preferably the improved glue 285 of the invention is coated onto the exposed surface of the microporous polypropylene layer of the CELGARD separator, but alternatively may be coated onto the polypropylene fiber side. As above mentioned zinc/air button cells typically have overall diameter between about 4 and 20 mm and an overall height of between about 2 and 9 mm. Separators for such cells are in the form electrolyte permeable sheets consisting of a nonwoven layer and a microporous layer with a total thickness separator thickness of between about 2 and 6 mil (0.0508 mm and 0.152 mm). The improved glue 285 (dried) is also permeable to electrolyte, but its coating thickness (dried) is much thinner than the separator sheet thickness. That is, improved glue 285 (dried) forms a very thin film typically of less than about 1 mil, for example, between about 0.05 and 0.6 mil (0.00127 and 0.0152 mm), adhesively bonding separator 238 to the cathode 233. Such thin film of glue 285 have limited absorption into the microporous or fibrous layer of desired separators, such as polypropylene separators. As such, improved glue 238 does not impede the transport of electrolyte through the separators. Also, in addition to its durable adhesive properties it seems to prevent separator 238 from drying out, especially when the anode is loaded at high zinc/electrolyte weight ratio, e.g. between about 3.3 and 6.0.

### Preparation of Representative Improved Separator Glue

A representative separator glue of the invention resulting in a polyvinylalcohol crosslinked with a boron containing compound can be prepared as follows:

The following glue mixture contained 5 parts by weight boric acid powder (H₃BO₃) per 100 parts by weight polyvinylalcohol (dry basis). A batch of the glue was prepared by first mixing 0.7365 g of boric acid powder from Fisher Scientific Co. in 250 g of distilled water and stirring the mixture in a beaker without heat until all the boric acid agglomerates dissolved. Then 14.56 g the polyvinylalcohol (PVA) powder (ELVANOL 71-30 from E.I. DuPont) was added to the boric acid/water solution. The mixture was stirred cold for a few minutes or until a milky white suspension mixture was obtained. The suspension was then heated to a temperature in a range between about 80° C. to 90° C. and then held (cooked) within that temperature range for about 1 hour. The suspension turns into a clear solution which is then allowed to cool to ambient temperature while continually mixing. Upon cooling the improved glue 285 is now prepared and ready for coating onto the separator 238 surface orbit may be stored under room temperature conditions for future application.

In a test sample, the prepared glue 285 was applied with a plastic syringe onto the microporous (shiny) side of a CELGARD CG5550 polypropylene separator sheet 238. A Myer drawdown rod (0.011 inch wire) was then used to meter the glue evenly onto the surface of both the separator 238 and exposed surface of catalytic cathode material 233. The cathode 233 was in the shape of a flat or substantially flat disk of material coated and compacted onto mesh screen 237 forming cathode composite 234. Alternatively cathode 233 may have a domed shape, for example, as shown in U.S. Pat. No. 3,897,265, herein incorporated by reference. A Teflon barrier sheet 235 was already laminated to the opposite side (mesh screen 237 side) of composite 234 as shown in FIG. 2. The glue coated side of the separator 238 was then pressed onto the cathode 233 surface to form a separator/cathode laminate thus forming the completed cathode assembly 230. A 0.75 inch nickel rod was rolled over the laminate (cathode assembly 230) to smooth out any bubbles or surface irregularities. The laminate was then sandwiched between two aluminum perforated plates and placed in an oven at 38° C. for about 2 hours in order to dry the glue producing thereby a very strong separator/cathode adhesive bond. The laminate (cathode assembly 230) was then cut to size and was ready for insertion into the cathode casing 240 of the zinc/air cell.

The following is the composition (wet) of the preferred improved glue 238 of the invention (5 parts by weight boric acid and 100 parts by weight polyvinylalcohol powder) which was made in accordance with the above described protocol.

Representative Improved Separator Glue Composition
(5 parts by weight boric acid powder (H₃BO₃) per 100 parts
by weight polyvinylalcohol powder)

| | Wt. % |
|---|---|
| Polyvinylalcohol (PVA) | 5.490 |
| Elvanol 71-30 (powder) | |
| Boric acid (H₃BO₃) | 0.274 |
| Distilled water | 94.236 |
| Total | 100.000 |

### Preparation of Comparative Separator Glue

A comparative glue was formed of a polyvinylalcohol/water solution (boric acid free). That is, ELVANOL 71-30 was dissolved in distilled water and heated to 80 to 90° C. without adding boric acid or other external crosslinking agent. Specifically, a batch of the comparative glue was prepared by mixing 14.56 g of unmodified polyvinylalcohol powder (ELVANOL 71-30) in 250 g of distilled water at ambient temperature to form a suspension. The suspension was then heated to a temperature between about 80° C. to 90° C. and held within that temperature for about 1 hour. The mixture was allowed to cool to ambient temperature, thereby forming the comparative glue which could be stored in a vessel until needed. The comparative glue was applied with a plastic syringe onto the microporous (shiny) side of a CELGARD CG5550 polypropylene separator sheet 238. A Myer drawdown rod (0.011 inch wire) was then used to meter the glue evenly onto the surface of both the separator 238 and exposed surface of catalytic cathode 233 in the same manner as described above with respect to the improved glue. The cathode composite 234 and cathode 233 in each case was flat and of identical composition, that is, whether the comparative glue or improved glue was used. The separator 238 coated on one side with the comparative glue was then pressed onto the cathode surface 233 to form a separator/cathode laminate (cathode assembly). A 0.75 inch nickel rod was rolled over the laminate to smooth out any bubbles or surface irregularities. The laminate was then sandwiched between two aluminum plates and placed in an oven at 38° C. for about 2 hours in order to dry the glue producing a separator/cathode adhesive bond. Full crosslinking of the polyvinyalcohol with the boron containing compounds to form a crosslinked polyvinylalcohol containing boron occurs upon drying, whereupon a durable separator/cathode adhesive bond of needed ionic conductivity, particularly at the cell's mid life, is formed. The laminate (cathode assembly 230) was then cut to size and was ready for insertion into the cathode casing 240 of the zinc/air cell.

The following is the composition (wet) of the comparative glue.

Comparative Glue Composition

| | Wt. % |
|---|---|
| Polyvinylalcohol (PVA) | 5.5 |
| Elvanol 71-30 | |
| Distilled water | 94.5 |
| Total | 100.0 |

### Test Examples with Improved Separator Glue Compared to Conventional Separator Glue and Discussion of the Test Results

The following examples indicate the use and effectiveness of the improved separator glue 285 of the invention compared to a base case using unmodified polyvinylalcohol separator glue when used within the zinc/air button cell described herein.

A comparative set of 312 size zinc/air button cells (8 identical cells) were made in accordance with the structural embodiments shown and described with respect to FIGS. 1 and 2 herein. The cells were zinc/air button cells of standard 312 size (7.72 mm diam.×3.43 mm height). A flat catalytic cathode mixture 233 coated onto mesh screen 237 forming cathode composite 234 was employed as shown in FIG. 2. (An electrolyte barrier sheet 235 of Teflon was laminated to the exposed side of mesh 237.) The anode comprised zinc particles (200 micron average size) with 3 wt. % mercury added based on the weight of zinc. The zinc/electrolyte weight ratio in the anode was high at about 4.2. The aqueous electrolyte was at a KOH concentration of 35 wt % KOH and 2 wt % ZnO. The anode mixture had the following composition: zinc particles, 80.6 wt. %; aqueous electrolyte, 19.1 wt. %; gelling agent, 0.3 wt %.

The cathode material 233 had the following composition: Manganese oxides (MnO₂, Mn₂O₃, and Mn₃O₄) (6 wt. %); carbon black particles (51.5 wt. %) and Teflon binder (42.5 wt. %). The cathode composite 234 which comprised the cathode material 233 coated and compacted onto mesh screen 237 was a flat disk of between about 9 and 14 mils (0.229 and 0.356 mm) thickness. The separator 238 was CELGARD CG5550 comprising a microporous polypropylene layer laminated to a nonwoven layer of polypropylene fibers. The above described comparative glue was coated onto the microporous (shiny) side of the CELGARD polypropylene separator and also the exposed surface of cathode 233. The glue coated separator was then pressed onto the cathode surface to form the separator/cathode laminate as above described. The separator/cathode laminate (cathode assembly 230) was then cut to size and inserted into the cathode casing of a 312 size zinc/air button cell.

A set of test zinc/air button cells (8 identical cells) were made in accordance with the structural embodiments shown and described with respect to FIGS. 1 and 2 herein. The test cells were of same 312 size and identical in construction and had the same separator and same anode and cathode composition as the comparative cells above described with but one exception. In the test cells the improved glue 285 of the invention (see above for glue preparation) was used to adhere the separator 238 to the cathode 233 surface. Separator 238 (CELGARD CG5550) had a thickness of about 3.7 mils (0.094 mm). After the separator/cathode laminate (cathode assembly 230) was dried a dry (crosslinked) film of improved glue 285 of thickness between about 0.05 and 0.6 mil (0.00127 and 0.0152 mm) was formed to adhesively bond separator 238 to cathode 233.

The comparative zinc/air button cells (8 cells size 312) and the test zinc/air button cells (8 cells size 312) were discharged according to the IEC (International Electrotechnical Commission) proposed HRHA test protocol. The Proposed IEC HRHA test is as follows: The cells are discharged at a rate of 2 mAmp constant current for 2 hours followed immediately by a 100 millisecond pulse of 10 mAmp current. The tests are repeated for six such 2 hour cycles (total 12 hours) and then followed by 12 hours rest. The complete cycle is repeated until a service life cut off voltage of 0.90 Volts is reached. The comparative and test cells were all discharged in accordance with the IEC proposed HRHA test.

The voltage discharge profile of the comparative and test cells were examined after they were aged for a period. In particular the mid-life voltage dip for the comparative and test cells was examined. (The mid-life voltage dip occurred within about plus or minus 10% of the midpoint of the service life of the cells.) The comparative cells (using conventional unmodified PVA separator glue) exhibited an 8 cell average minimum mid-life running voltage (average of 8 comparative cells at point of maximum voltage dip) of 1.092V and the test cells (using improved separator glue of the invention) exhibited an 8 cell average minimum mid-life running voltage of 1.171V (average of 8 test cells at point of maximum voltage dip). Thus the test cells had a significantly higher mid-life running voltage than the comparative cells. Specifically, the test cells (using improved separator glue) had a 7.2% higher running voltage at the cell's mid-life than the comparative cells. That is, the mid-life voltage “dip” of the test cells (with improved separator glue) was much smaller than the mid-life voltage dip of the comparative cells (with conventional separator glue).

In a preferred embodiment of the zinc/air cell the edge of cathode catalytic assembly 230 can be applied to adhesive ring 143 on step 245 thereby providing a permanent adhesive seal between the cathode assembly 230 and casing step 245. The cathode catalytic assembly 230 can be applied to adhesive 143 on step 245 with the electrolyte barrier 235 contacting adhesive 143 directly. (Optionally an additional electrolyte barrier sheet 232 (FIGS. 1 and 2) may be overlaid on electrolyte barrier 235 and bonded to adhesive 143 as described in the following paragraph.) The use of adhesive sealant 143 also reduces the amount of crimping force needed during crimping the outer peripheral edge 242b over the anode casing body. This is particularly advantageous with thin walled anode and cathode casings 240 and 260 of wall thickness between about 0.001 inches (0.0254 mm) and 0.015 inches (0.38 mm), particularly with anode and cathode casing wall thicknesses between about 0.002 and 0.005 inches (0.0508 and 0.127 mm). The use of adhesive sealant 143 is also advantageous when thin catalytic cathode assemblies 230 are employed since high crimping forces could possibly distort or crack such thin casings and cathode assemblies.

A preferred embodiment of a complete zinc/air cell of the invention is shown in FIG. 1. The embodiment shown in FIG. 1 is in the form of a miniature button cell. The cell 210 comprises a cathode casing 240 (cathode can) an anode casing 260 (anode can) with an electrical insulator material 270 therebetween. The insulator 270 can desirably be in the form of a ring which can be inserted over the outside surface of the anode casing body 263 as shown in FIG. 1. A water resistant sealing paste such as an asphalt or bitumen based sealant or polymeric sealant such a polyamide can be applied between the insulator 270 side wall and the anode casing outer wall 263e. The sealant (not shown) may be applied to the inside surface of insulator 270 wall before the insulator ring 270 is inserted over the anode can wall 263e. Insulator ring 270 desirably has an enlarged portion 273a extending beyond peripheral edge 263d of anode casing 240 (FIG. 1) forming an “L” shape configuration in cross section. The insulator 270 with enlarged portion 273a prevents anode active material from contacting the cathode casing 240 after the cell is sealed. Insulator 270 is of a durable electrically insulating material such as high density polyethylene, polypropylene or nylon which resists cold flow when squeezed.

The anode casing 260 and cathode casing 240 are initially separate pieces. The anode casing 260 and cathode casing 240 are separately filled with active materials, whereupon the open end 267 of the anode casing 260 can be inserted into the open end 247 of cathode casing 240. The anode casing 260 can have a folded side wall formed of a first outer straight body portion 263e which extends vertically upwards (FIG. 1) forming the casing 260 outer side walls. The straight body portion 263e may desirably be folded over once at edge 263d to form a first downwardly extending inner portion 263a of the anode casing side wall. The folded portions 263a and 263e thus form a double-sided wall which together provide spring-like tension and additional support between the anode casing body 263 and abutting seal wall 270. This helps to maintain a tight seal between the anode and cathode casings. Alternatively, the side walls of the anode casing 240 can be formed as a single wall 263a without folded portion 263e. However, the anode casing 240 with the folded (double) side wall, as shown in the figures herein, has been determined to be desirable for very thin walled casing, for example, having a wall thicknesses between about 2 and 5 mil (0.0508 and 0.127 mm, which thickness ranges apply to each fold 263a and 263e. These thickness ranges also apply to the closed end 269 of the anode can. In the anode casing having a folded side wall (FIG. 1), the inner side wall portion 263a terminates in an inwardly slanted portion 263b which terminates in a second downwardly extending vertical portion 263c. The second straight portion 263c is of smaller diameter than straight portion 263a. The portion 263c terminates with a 90° bend forming the closed end 269 having a preferably flat negative terminal surface 265.

The body 242 of cathode casing 240 has a straight portion 242a of maximum diameter extending vertically downwardly from closed end 249. The body 242 terminates in peripheral edge 242b. The peripheral edge 242b of cathode casing 240 and underlying peripheral edge 273b of insulator ring 270 are initially vertically straight as shown in FIGS. 3 and 4 and can be mechanically crimped over the slanted midportion 263b of the anode casing 260 as shown in FIG. 5. Such crimping locks the cathode casing 240 in place over the anode casing 260 and forms a tightly sealed cell.

Anode casing 260 can be separately filled with anode active material by first preparing a mixture of particulate zinc and powdered gellant material. The zinc average particle size is desirably between about 30 and 350 micron. The zinc can be pure zinc but is preferably in the form of particulate zinc alloyed with indium (100 to 1500 ppm). The zinc can also be in the form of particulate zinc alloyed with indium (100 to 1000 ppm) and lead (100 to 1000 ppm). Other alloys of zinc, for example, particulate zinc alloyed with indium (100 to 1500 ppm) and bismuth (100 to 1000 ppm) can also be used. In this context there is desirably zero added mercury in the anode. These particulate zinc alloys are essentially comprised of pure zinc and have the electrochemical capacity essentially of pure zinc. Thus, the term “zinc” shall be understood to include such materials.

The gellant material can be selected from a variety of known gellants which are substantially insoluble in alkaline electrolyte. Such gellants can, for example, be cross linked carboxymethyl cellulose (CMC); starch graft copolymers, for example in the form of hydrolyzed polyacrylonitrile grafted unto a starch backbone available under the designation Waterlock A221 (Grain Processing Corp.); cross linked polyacrylic acid polymer available under the trade designation Carbopol C940 (B.F. Goodrich); alkali saponified polyacrylonitrile available under the designation Waterlock A 400 (Grain Processing Corp.); and sodium salts of polyacrylic acids termed sodium polyacrylate superabsorbent polymer available under the designation Aqua Keep J-550. A dry mixture of the particulate zinc and gellant powder can be formed with the gellant forming typically between about 0.1 and 1 percent by weight of the dry mixture. A solution of aqueous KOH electrolyte solution comprising between about 30 and 40 wt % KOH and about 2 wt % ZnO is added to the dry mixture and the formed wet anode mixture 250 can be inserted into the anode casing 260. Alternatively, the dry powder mix of particulate zinc and gellant can be first placed into the anode casing 260 and the electrolyte solution added to form the wet anode mixture 250.

A catalytic cathode assembly 230 (FIGS. 1 and 2) and air diffuser 231 can be inserted into casing 240 as follows: An air diffuser material 231 (FIG. 1), which can be in the form of an air porous filter paper or porous polymeric material can be inserted into the air inlet region 288 of the cathode casing 240 so that it lies against the inside surface of raised portion 244 of the casing against air holes 243. (Air inlet region 288 is the region underlying the air holes 243 and thus lies between the inside surface of cathode casing portion 244 and cathode assembly 230 including any electrolyte barrier layer 232 thereon.) An adhesive sealant ring 143 is desirably applied to the inside surface 245a of recessed step 245 at the closed end of the cathode casing. A separate electrolyte barrier layer 232 (FIGS. 1 and 2), for example, of polytetrafluroethylene (Teflon) which becomes a part of the cathode assembly 230 can optionally be inserted on the underside of the air diffuser material 231 so that the edge of the barrier layer 232 contacts adhesive ring 143. Barrier layer 232 is permeable to air but not permeable to the alkaline electrolyte or water. The adhesive ring 143 thus permanently bonds the edge of barrier layer 232 to the inside surface of recessed step 245. The adhesive ring 143 with barrier layer 232 bonded thereto prevents electrolyte from migrating from the anode to and around cathode catalytic assembly 230 and then leaking from the cell through air holes 243.

A catalytic cathode assembly 230 as shown in FIG. 2 can be prepared as a laminate comprising a layer of electrolyte barrier material 235, a cathode composite disk 234 under the barrier layer 235 and a layer of ion permeable separator material 238 under the catalyst composite 234, as shown in FIG. 2. Preferably catalyst composite 234 is oriented so that electrolyte barrier material 235 is applied to catalyst composite 234 so that it abuts or is closer to the mesh screen 237 side of catalyst composite 234. Conversely, separator 238 is preferably applied to the side of catalyst composite 234 which is further away from mesh screen 237, that is, so that separator 238 contacts catalytic cathode mixture 233 directly (FIG. 2). The separator 238 can be selected from conventional ion permeable separator materials including polyvinylalcohol, cellophane, polyvinylalcohol, polyvinylchloride, polyvinylacetate/cellulose, acrylonitrile, fibrous or microporous polypropylene, or polyamide nonwoven fiber. The electrolyte barrier layers 232 and 235 can desirably be of polytetrafluroethylene (Teflon).

Catalytic cathode composite 234 desirably comprises a catalytic cathode mixture 233 of particulate manganese dioxide, carbon, and hydrophobic binder which is applied by conventional coating methods to a surface of an electrically conductive screen 237. Screen 237 may be of woven metallic fibers, for example, nickel or nickel plated steel fibers. The cathode mixture 233 is formed in the shape of a flat or at least substantially flat disk, which may be termed herein as the cathode disk. Other catalytic materials may be included or employed such as metals like silver, platinum, palladium, and ruthenium or other oxides of metals or manganese (MnOₓ) and other components known to catalyze the oxygen reduction reaction. During application the catalytic mixture 233 is coated and compacted onto porous mesh of screen 237 so that much of it becomes absorbed into the screen mesh. The manganese dioxide used in the catalytic mixture 233 can be conventional battery grade manganese dioxide, for example, electrolytic manganese dioxide (EMD). The carbon used in preparation of mixture 233 can be in various forms including graphite, carbon black and acetylene black. A preferred carbon is carbon black because of its high surface area. A suitable hydrophobic binder can be polytetrafluroethylene (Teflon). The catalytic mixture 233 may typically comprise between about 3 and 12 percent by weight manganese oxides, 30 and 55 percent by weight carbon, and remainder binder. During cell discharge the catalytic mixture 233 acts primarily as a catalyst to facilitate the electrochemical reaction involving the incoming air. However, additional manganese dioxide can be added to the catalyst along with electrolyte and the cell can be converted to an air assisted zinc/air or air assisted alkaline cell. In such cell, which can be in the form of a button cell, at least a portion of manganese dioxide becomes discharged, that is, some manganese is reduced during electrochemical discharge along with incoming oxygen. It will be appreciated that the improved glue 285 of the invention can also be used to adhere electrolyte permeable separator material to cathodes of such air assisted cells.

In the preferred embodiment (FIG. 1) the anode casing 260 has a layer of copper 266 plated or clad on its inside surface so that in the assembled cell the zinc anode mix 250 contacts the copper layer. The copper plate is desired because it provides a highly conductive pathway for electrons passing from the anode 250 to the negative terminal 265 as the zinc is discharged. The anode casing 260 is desirably formed of stainless steel which is plated on the inside surface with a layer of copper. Preferably, anode casing 260 is formed of a triclad material composed of stainless steel 264 with a copper layer 266 on its inside surface and a nickel layer 262 on its outside surface as shown in FIG. 1. Thus, in the final assembled cell 210 (FIG. 1) the copper layer 266 forms the anode casing inside surface in contact with the zinc anode mix 250 and the nickel layer 262 forms the anode casing's outside surface.

By way of a specific non-limiting example, the cell size could be a standard size 312 zinc/air cell having an outside diameter of between about 0.3025 and 0.3045 inches (7.68 and 7.73 mm) and a height of between about 0.1300 and 0.1384 inches (3.30 and 3.52 mm). The anode 250 can contain zero added mercury (mercury content can be less than 50 parts mercury per million parts by weight of zinc). It will be appreciated that the improved separator glue 285 of the invention can also be used beneficially with in zinc/air cell with zero added mercury. A desirable representative anode mixture (with zero added mercury) and elevated zinc/electrolyte weight ratio can thus have the following composition (e.g. Zinc/electrolyte weight ratio of 4.2): zinc 80.6 wt. % (the zinc can be alloyed with 200 to 800 ppm each of indium and lead), electrolyte 19.1 wt. % (35 wt % KOH and 2 wt % ZnO), gelling agent (0.3 wt %). Sufficient anode material 250 is supplied to fill for example, between about 70 and 80 percent, typically between about 70 and 75 percent of the anode cavity (internal volume of anode casing 260 bounded on top by separator 238). The cathode catalyst composite 234 can have the following composition: Manganese oxides (MnO₂, Mn₂O₃, and Mn₃O₄) (6 wt. %); carbon black particles (51.5 wt. %) and Teflon binder (42.5 wt. %).

The adhesive sealant 143 can be applied as a continuous ring to the inside surface of the cathode casing recessed step 245. The adhesive 143 to be applied to the inside surface 245a of step 245 may be a solvent based mixture comprising a polyamide based adhesive component as described in U.S. Pat. No. 6,436,156 B1 and incorporated herein by reference. The adhesive component is thus desirably a low molecular weight thermoplastic polyamide resin. It is as a dimerized fatty acid which is the reaction product of a dimerized fatty acid and diamine. The adhesive mixture may be formed by dissolving the REAMID-100 polyamide in a solvent of isopropanol 50 parts by weight and toluene 50 parts by weight. The polyamide adhesive layer 143 applied to the inside surface 245a of cathode casing step 245 provides a very strong bond between Teflon sheet 232 and the nickel plated cathode casing step 245. The adhesive 143 also is resistant to chemical attack from the potassium hydroxide electrolyte.

Cell 210 can be assembled by first inserting the cathode components above described into the precrimped cathode casing 240. The air diffuser material 231 is inserted against air holes 42 within air inlet space 288. An electrolyte barrier layer 232, preferably of Teflon, is placed over the air diffuser material 231. Preferably the inside surface 245a of the cathode casing step 245 is coated with the above described adhesive 143 so that the edge of electrolyte barrier layer 232 adheres to the inside surface 245a of step 245. Preferably, the bottom surface (facing the cell interior) of the enlarged portion 273a of the insulating sealing disk 270 is also coated with a ring of an adhesive 144 as shown in FIG. 1. Adhesive 144 may have the same composition as adhesive 143. Although the adhesive layers 143 and 144 can be omitted, it is desirably included, particularly for cells having anode and cathode casing wall thickness which are very thin. For example adhesive layers 143 and 144 is desirably included for cells 210 having anode and cathode casing wall thicknesses between about 2.0 and 5 mils (0.0508 and 0.127 mm).

The anode casing 260 may be drawn to the shape shown in FIG. 1, for example, having straight side walls formed of an inner portion 263a which is folded over once to form outer portion 263e. Thus, in effect a double side wall is formed of inner wall 263a and outer wall 263e. It will be appreciated that the anode casing 260 may be formed of a single (unfolded) side wall instead of the double side wall 263a and 263e shown. The double side wall is preferred if the anode casing 260 has very thin side walls, for example, between about 2 and 5 mil 0.0508 and 0.127 mm). An insulator seal ring 270 is applied over the anode casing side walls. The anode casing 260 is then filled with anode material 250 above described.

The cathode casing body 242 is then pushed over the outside surface insulator 270. Crimping forces are applied to crimp edge 242b of cathode casing 240 over slanted surface 263b of the anode casing 260 with insulator edge 273b therebetween. Radial forces may be applied during crimping to assure a tight seal between the anode and cathode casings.

Although the invention has been described with reference to specific embodiments, it should be appreciated that other embodiments are possible without departing from the concept of the invention. Thus, the invention is not intended to be limited to the specific embodiments but rather its scope is reflected by the claims and equivalents thereof.

What is claimed is:

1. A zinc/air depolarized cell comprising an anode casing and a cathode casing; an anode mixture comprising zinc particles and aqueous alkaline electrolyte within said anode casing; a cathode within said cathode casing; an electrolyte permeable separator between said cathode and anode; and a glue comprising a crosslinked polyvinylalcohol, said glue located between the separator and a side of said cathode to adhesively bond the separator to the cathode.

2. The cell of claim 1 wherein said glue comprises polyvinylalcohol crosslinked with a crosslinking agent comprising a boron containing compound.

3. The cell of claim 1 wherein said glue comprises polyvinylalcohol crosslinked with a crosslinking agent comprising polyamide-epichlorohydrin.

4. The cell of claim 1 wherein said glue comprises polyvinylalcohol crosslinked with a crosslinking agent comprising ammonium zirconium carbonate.

5. A zinc/air depolarized cell comprising an anode casing and a cathode casing; an anode mixture comprising zinc particles and aqueous alkaline electrolyte within said anode casing; a cathode within said cathode casing; an electrolyte permeable separator between said cathode and anode; and a glue comprising crosslinked polyvinylalcohol comprising boron, said glue located between the separator and a side of said cathode to adhesively bond the separator to the cathode.

6. The cell of claim 5 wherein said glue is made by applying an aqueous solution comprising polyvinylalcohol, water, and a boron containing compound as a coating between said separator and said cathode; wherein said coating is subsequently dried to crosslink at least a portion of said boron containing compound comprising boron with diol groups within the polyvinylalcohol structure, thereby adhesively bonding the separator to the cathode.

7. The cell of claim 5 wherein said glue is made by applying an aqueous solution comprising polyvinylalcohol, water, and boric acid as a coating between said separator and said cathode; and subsequently drying the coating to crosslink at least a portion of said boric acid comprising boron with diol groups within the polyvinylalcohol structure, thereby adhesively bonding the separator to the cathode.

8. The cell of claim 6 wherein said boron containing compound is selected from the group consisting of potassium borate, sodium borate, zinc borate, and boric acid, and mixtures thereof.

9. The cell of claim 6 wherein said glue forms a uniform layer between said separator and said cathode bonding said separator to said cathode, wherein said glue layer (dry) has a thickness between about 0.05 and 0.6 mil (0.00127 and 0.0152 mm).

10. The cell of claim 7 wherein the weight ratio of boric acid to polyvinylalcohol (dry basis) in said glue is between about 1/100 and 12/100.

11. The cell of claim 7 wherein the weight ratio of boric acid to polyvinylalcohol (dry basis) in said glue is between about 3/100 and 5/100.

12. The cell of claim 6 wherein said dried glue produces a durable adhesive bond between said separator and said cathode and has the additional function of permitting electrolyte from the anode to pass therethrough into the cathode.

13. The cell of claim 5 wherein said cathode has the configuration of a substantially flat disk.

14. The cell of claim 5 wherein said cathode has the configuration of a substantially domed shaped disk.

15. The cell of claim 5 wherein the separator comprises a layer of microporous polypropylene facing said cathode and said glue is applied onto said microporous polypropylene layer.

16. The cell of claim 5 wherein the separator comprises a layer of microporous polypropylene adhered to a layer of nonwoven polypropylene fibers wherein said nonwoven polypropylene fiber layer faces said cathode and said glue is applied onto said nonwoven polypropylene fiber layer.

17. The cell of claim 5 wherein said anode mixture comprises between about 76.7 and 85.7 percent by weight zinc and between about 14.3 and 23.3 percent by weight of said alkaline electrolyte.

18. The cell of claim 5 wherein the zinc/electrolyte weight ratio in said anode mixture is between about 3.3 and 6.0.

19. The cell of claim 5 wherein the zinc/electrolyte weight ratio in said anode mixture is between about 4.0 and 5.5.

20. The cell of claim 5 wherein said alkaline electrolyte comprises potassium hydroxide having a concentration therein of between about 32 and 40 percent by weight.

21. The cell of claim 5 wherein said cathode comprises manganese dioxide.

22. The cell of claim 5 wherein the interface between said cathode and separator with said glue therebetween is flat.

23. The cell of claim 5 wherein the separator is in the form of an electrolyte permeable sheet having a thickness between about 2 and 6 mil (0.0508 and 0.152 mm).

24. The cell of claim 5 wherein said cell comprises less than 50 parts by weight mercury per million parts by weight zinc.

25. A zinc/air button cell comprising an anode can and a cathode can; an anode mixture comprising zinc particles and aqueous alkaline electrolyte within said anode can; a cathode within said cathode can; an electrolyte permeable separator between said cathode and anode mixture; and a glue comprising crosslinked polyvinylalcohol comprising boron between the separator and a side of said cathode to adhesively bond the separator to the cathode; wherein the zinc/electrolyte weight ratio in said anode mixture is between about 3.3 and 6.0; wherein the cathode can comprises an open end and opposing closed end and integral side wall therebetween; said cathode can closed end having at least one air hole therethrough and said cathode is in proximity to said air hole; wherein said anode can comprises an open end and opposing closed end and integral side wall therebetween; wherein the open end of the anode can resides within the open end of the cathode can with at least a portion of the cathode can side wall overlapping at least a portion of the anode can side wall with electrically insulating material between said overlapping wall portions.

26. The cell of claim 25 wherein said glue is made by applying an aqueous solution comprising polyvinylalcohol, water, and a boron containing compound as a coating between said separator and said cathode; wherein said coating is subsequently dried to crosslink at least a portion of said boron containing compound comprising boron with diol groups within the polyvinylalcohol structure, thereby adhesively bonding the separator to the cathode.

27. The cell of claim 25 wherein said glue is made by applying an aqueous solution comprising polyvinylalcohol, water, and boric acid as a coating between said separator and said cathode; and subsequently drying the coating to crosslink at least a portion of said boric acid comprising boron with diol groups within the polyvinylalcohol structure, thereby adhesively bonding the separator to the cathode.

28. The cell of claim 26 wherein said boron containing compound is selected from the group consisting of potassium borate, sodium borate, zinc borate, boric acid, and mixtures thereof.

29. The cell of claim 26 wherein said glue is in the form of a uniform layer between said separator and said cathode bonding said separator to said cathode, wherein said glue layer (dry) has a thickness between about 0.05 and 0.6 mil (0.00127 and 0.0152 mm).

30. The cell of claim 27 wherein the weight ratio of boric acid to polyvinylalcohol (dry basis) in said glue is between about 1/100 and 12/100.

31. The cell of claim 27 wherein the weight ratio of boric acid to polyvinylalcohol (dry basis) in said glue is between about 3/100 and 5/100.

32. The cell of claim 25 wherein said dried glue produces a durable adhesive bond between said separator and said cathode and has the additional function of permitting electrolyte from the anode to pass therethrough into the cathode.

33. The cell of claim 25 wherein said cathode has the configuration of a substantially flat disk.

34. The cell of claim 25 wherein said cathode has the configuration of a substantially domed shaped disk.

35. The cell of claim 26 wherein the separator comprises a layer of microporous polypropylene facing said cathode and said glue is coated onto said microporous polypropylene layer.

36. The cell of claim 26 wherein the separator comprises a microporous layer adhered to a layer of nonwoven fibers wherein said nonwoven fiber layer faces said cathode with said glue coated onto said nonwoven fiber layer.

37. The cell of claim 25 wherein said anode mixture comprises between about 76.7 and 85.7 percent by weight zinc and between about 14.3 and 23.3 percent by weight of said alkaline electrolyte.

38. The cell of claim 25 wherein the zinc/electrolyte weight ratio in said anode mixture is between about 4.0 and 5.5.

39. The cell of claim 25 wherein said alkaline electrolyte comprises potassium hydroxide having a concentration therein of between about 32 and 40 percent by weight.

40. The cell of claim 25 wherein said cathode comprises manganese dioxide.

41. The cell of claim 25 wherein the interface between the cathode and separator with said glue therebetween is flat.

42. The cell of claim 25 wherein the separator is in the form of an electrolyte permeable sheet having a thickness between about 2 and 6 mil (0.0508 and 0.152 mm).

43. The alkaline cell of claim 25 wherein the zinc particles include zinc alloy particles.

44. The alkaline cell of claim 25 wherein the zinc alloy particles comprising between about 100 and 1500 parts by weight indium per million parts by weight zinc in said zinc alloy particles.

45. The cell of claim 25 wherein said cell comprises less than 50 parts by weight mercury per million parts by weight zinc.

46. The alkaline cell of claim 25 wherein said zinc particles in the anode mixture have an average particle size between about 30 and 350 micron.

47. The cell of claim 25 wherein said cell has an overall diameter of between about 4 and 20 mm and an overall height of between about 2 and 9 mm.
